(19) United States
(12) Patent Application Publication
(10) Pub. No.: US 2002/0173333 A1
(43) Pub. Date: Nov. 21, 2002

(54) Method and apparatus for processing barge-in requests

(76) Inventors: Dale R. Buchholz, Palatine, IL (US); Mihaela K. Mihaylova, Schaumburg, IL (US); Jeffrey A. Meunier, Chicago, IL (US)

Correspondence Address: Christopher P. Moreno, Vedder, Price, Kaufman & Kammholz, 222 N. LaSalle Street, Chicago, IL, 60601, US

(21) Appl. No.: 09/861,354

(22) Filed: May 18, 2001

(51) Int. Cl. H04B 7/00

(52) U.S. Cl. 455/527; 455/517

(57) ABSTRACT

Based on local detection of input events at a subscriber unit, presentation of subscriber-targeted information (e.g., audio or visual data) may be quickly halted in response to a barge-in request indicated by an input event. The determination whether a given input event constitutes a valid barge-in request is preferably based on input event prioritization data provided to the subscriber from, for example, a server running one or more applications currently communicating with the subscriber unit. Furthermore, detection of an input event indicative of a barge-in request at a subscriber unit causes the subscriber unit to transmit a message to the source of the subscriber-targeted information (e.g., the server), which message in turn causes the information source to discontinue presentation of the subscriber-targeted information. In this manner, the present invention provides a technique for quickly responding to barge-in requests regardless of the delay characteristics of the underlying communication system.

### CROSS-REFERENCE TO RELATED APPLICATIONS

Related applications are prior U.S. patent application Ser. No. 09/412,202, entitled METHOD AND APPARATUS FOR PROCESSING AN INPUT SPEECH SIGNAL DURING PRESENTATION OF AN OUTPUT AUDIO SIGNAL, and prior U.S. patent application Ser. No. 09/412,699, entitled SPEECH RECOGNITION TECHNIQUE BASED ON LOCAL INTERRUPT DETECTION, both filed on Oct. 5, 1999 by Gerson, which prior applications are assigned to Auvo Technologies, Inc., the same assignee as in the present application, and which prior applications are hereby incorporated by reference verbatim, with the same effect as though the prior applications were fully and completely set forth herein.

### TECHNICAL FIELD

The present invention relates generally to communication systems incorporating speech recognition and, in particular, to a method and apparatus for processing “barge-in” requests during a wireless communication.

### BACKGROUND OF THE INVENTION

Speech recognition systems are generally known in the art, particularly in relation to telephony systems. U.S. Pat. Nos. 4,914,692; 5,475,791; 5,708,704; and 5,765,130 illustrate exemplary telephone networks that incorporate speech recognition systems. A common feature of such systems is that the speech recognition element (i.e., the device or devices performing speech recognition) is typically centrally located within the fabric of the telephone network, as opposed to at the subscriber's communication device (i.e., the user's telephone). In a typical application, a combination of speech synthesis and speech recognition elements is deployed within a telephone network or infrastructure. Callers may access the system and, via the speech synthesis element, be presented with informational prompts or queries in the form of synthesized or recorded speech. A caller will typically provide a spoken response to the synthesized speech and the speech recognition element will process the caller's spoken response in order to provide further service to the caller.

Given human nature and the design of some speech synthesis/recognition systems, user inputs provided by a caller will often occur during the presentation of audio or visual output, for example, a synthesized speech prompt or a series of graphically displayed elements. The processing of such occurrences is often referred to as “barge-in” processing. U.S. Pat. Nos. 4,914,692; 5,155,760; 5,475,791; 5,708,704; and 5,765,130 all describe techniques for barge-in processing in the context of voice-based user inputs. Generally, the techniques described in each of these patents address the need for echo cancellation during barge-in processing. That is, during the presentation of a synthesized speech prompt (i.e., an output audio signal), the speech recognition system must account for residual artifacts from the prompt being present in any spoken response provided by the user (i.e., an input speech signal) in order to effectively perform speech recognition analysis. Thus, these prior art techniques are generally directed to the quality of input speech signals during barge-in processing. Additionally, it is known in the art to provide non-voice-based user inputs as another form of barge-in. For example, users are often instructed to press certain keys in a telephone keypad in response to pre-recorded prompts and the like. The resulting DTMF (dual tone, multi-frequency) tones signal the infrastructure of the user's particular response.

Regardless of the manner in which a user initiates a barge-in, perceived performance of such systems is significantly impacted by the responsiveness of the system to each user's barge-in signals. That is, once a user has barged-in during an audible prompt, or during presentation of other types of information, the user expects the system to quickly respond to the change of context manifested by the user's barge-in. For example, if a user is presented with a long series of prompts requesting him or her to speak a number corresponding to a certain option, or to press a button corresponding to such a number, the user typically expects that the system will discontinue presentation of the prompts once he or she has responded. The relatively small latencies or delays typically found in voice telephony (i.e., circuit switched) systems are conducive to quick recognition of barge-ins and responses thereto by centralized systems capable of recognizing barge-in inputs from users.

However, the low latencies and delays found in prior art voice telephony systems are not necessarily the norm in newer, wireless and/or packet-based systems. Although a substantial body of prior art exists regarding telephony-based speech recognition systems, the incorporation of speech recognition systems into wireless communication systems or into packet-based networks is a relatively new development. For example, in an effort to standardize the application of speech recognition in wireless communication environments, work has recently been initiated by the European Telecommunications Standards Institute (ETSI) on the so-called Aurora Project. A goal of the Aurora Project is to define a global standard for distributed speech recognition systems. Generally, the Aurora Project is proposing to establish a client-server arrangement in which front-end speech recognition processing, such as feature extraction or parameterization, is performed within a subscriber unit (e.g., a hand-held wireless communication device such as a cellular telephone). The data provided by the front-end would then be conveyed to a server to perform back-end speech recognition processing.

It is anticipated that the client-server arrangement being proposed by the Aurora Project will adequately address the needs for a distributed speech recognition system. However, it is uncertain at this time how barge-in processing will be addressed, if at all, by the Aurora Project. This is a particular concern given the wider variation in latencies typically encountered in wireless systems and the effect that such latencies could have on barge-in processing. For example, if traditional barge-in recognition processing were to be used in a client-server, wireless and/or packet-based model, it is anticipated that the varying delays incurred between the client and the server could seriously degrade the perceived barge-in responsiveness of such a system. Thus, it would be advantageous to provide techniques for processing barge-in occurrences, particularly in systems having uncertain and/or widely varying delay characteristics, such as those utilizing wireless and/or packet data communications.

### SUMMARY OF THE INVENTION

The present invention provides a technique for processing input events indicative of barge-in requests in a timely and responsive manner. Although principally applicable to wireless communication systems, the techniques of the present invention may be beneficially applied to any communication system having uncertain and/or widely varying delay characteristics, for example, a packet-data system, such as the Internet. In particular, the present invention provides a technique for quickly halting the presentation of subscriber-targeted information (e.g., audio or visual data received from an infrastructure-based server) in response to a barge-in request. In accordance with one embodiment of the present invention, an input event is detected at a subscriber unit. In response, presentation of the subscriber-targeted information as output at the subscriber unit is halted substantially immediately. In accordance with another embodiment of the present invention, the determination whether a given input event constitutes a valid barge-in request is based on input event prioritization data provided to the subscriber from, for example, a server running one or more applications currently communicating with the subscriber unit. In yet another embodiment of the present invention, detection of an input event indicative of a barge-in request at a subscriber unit causes the subscriber unit to transmit a message to the source of the subscriber-targeted information (once again, typically a server), which message in turn causes the information source to discontinue presentation of the subscriber-targeted information. In this manner, the present invention provides a technique for quickly responding to barge-in requests regardless of the delay characteristics of the underlying communication system.

### BRIEF DESCRIPTION OF THE DRAWINGS

FIG. 1 is a block diagram of a wireless communications system in accordance with the present invention.

FIG. 2 is a block diagram of a subscriber unit in accordance with the present invention.

FIG. 3 is a schematic illustration of functionality within a subscriber unit in accordance with the present invention.

FIG. 4 is a block diagram of a server in accordance with the present invention.

FIG. 5 is a schematic illustration of functionality within a server in accordance with the present invention.

FIG. 6 illustrates an embodiment of input event prioritization data in accordance with the present invention.

### DETAILED DESCRIPTION OF THE PREFERRED EMBODIMENT

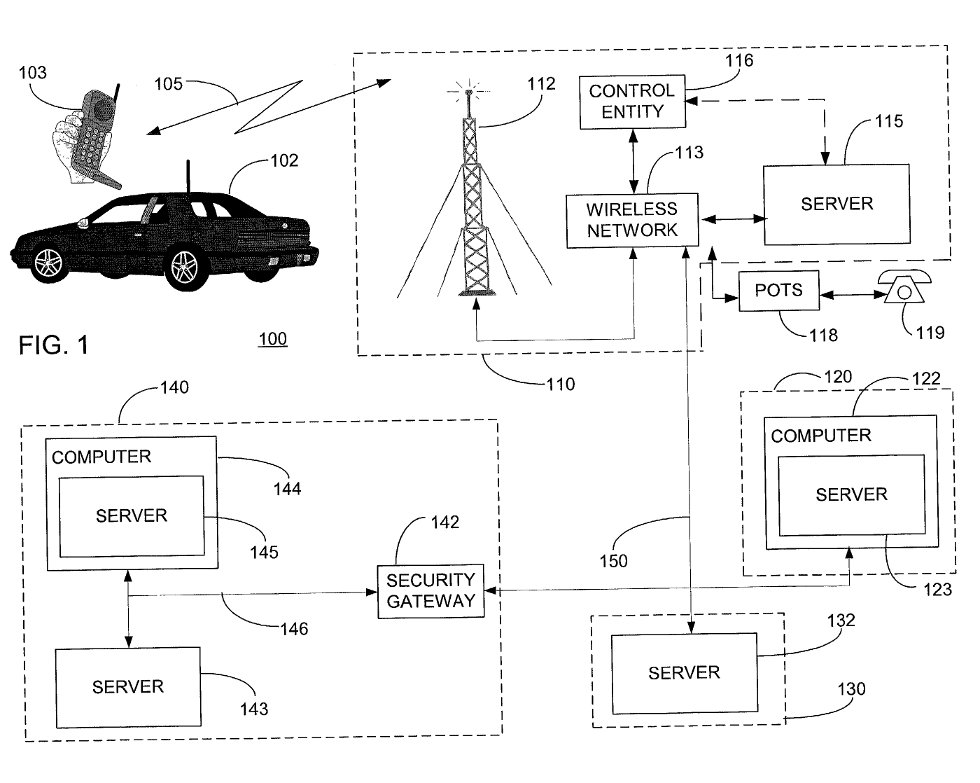

The present invention may be more fully described with reference to FIGS. 1-6. FIG. 1 illustrates the overall system architecture of a wireless communication system 100 comprising subscriber units 102-103. The subscriber units 102-103 communicate with an infrastructure via a wireless channel 105 supported by a wireless system 110. The infrastructure of the present invention may comprise, in addition to the wireless system 110, any of a small entity system 120, a content provider system 130 and an enterprise system 140 coupled together via a data network 150. Additionally, subscriber units may be coupled directly (not shown) to the data network 150 as in the case, for example, of a computer coupled to a private or public data network. In general, the present invention is applicable to those systems in which subscriber units, that may act as sources of barge-in requests, are capable of communicating with infrastructure-based resources, such as servers, via variable-delay communications paths, such as may be found in wireless and/or packet switched networks. For the sake of simplicity, the following description is focused on wireless subscriber units with the understanding that the present invention is equally applicable to other variable-delay networks as just described.

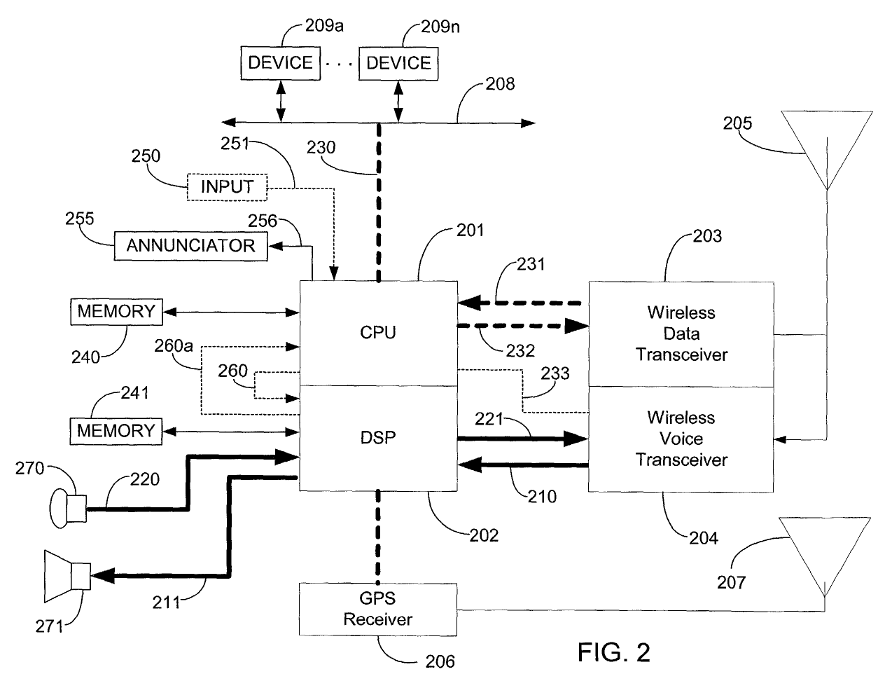

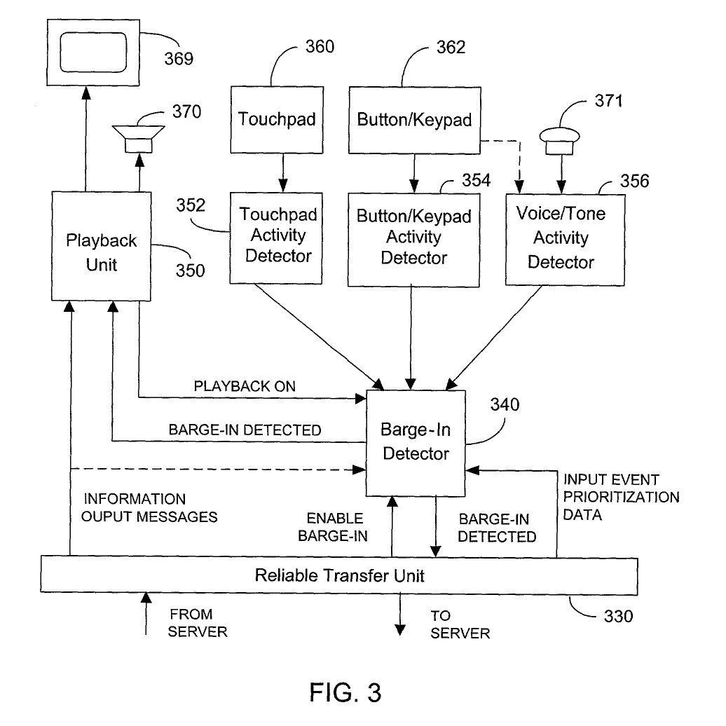

The subscriber units may comprise any wireless communication device, such as a handheld cellphone 103 or a wireless communication device residing in a vehicle 102, capable of communicating with a communication infrastructure. It is understood that a variety of subscriber units, other than those shown in FIG. 1, could be used; the present invention is not limited in this regard. The subscriber units 102-103 preferably include the components of a hands-free cellular phone, for hands-free voice communication, and the client portion of a client-server speech recognition and synthesis system. These components are described in greater detail below with respect to FIGS. 2 and 3.

The subscriber units 102-103 wirelessly communicate with the wireless system 110 via the wireless channel 105. The wireless system 110 preferably comprises a cellular system, although those having ordinary skill in the art will recognize that the present invention may be beneficially applied to other types of wireless systems supporting voice or data communications. The wireless channel 105 is typically a radio frequency (RF) carrier implementing digital transmission techniques and capable of conveying speech and/or data both to and from the subscriber units 102-103. It is understood that other transmission techniques, such as analog techniques, may also be used. In a preferred embodiment, the wireless channel 105 is a wireless packet data channel, such as the General Packet Data Radio Service (GPRS) defined by the European Telecommunications Standards Institute (ETSI). The wireless channel 105 transports data to facilitate communication between a client portion of the client-server speech recognition and synthesis system, and the server portion of the client-server speech recognition and synthesis system. Additionally, the wireless channel 105 serves to convey information regarding input events detected at the subscriber units as described in greater detail below. Other information, such as display, control, location, or status information can also be transported across the wireless channel 105.

The wireless system 110 comprises an antenna 112 that receives transmissions conveyed by the wireless channel 105 from the subscriber units 102-103. The antenna 112 also transmits to the subscriber units 102-103 via the wireless channel 105. Data received via the antenna 112 is converted to a data signal and transported to the wireless network 113. Conversely, data from the wireless network 113 is sent to the antenna 112 for transmission. In the context of the present invention, the wireless network 113 comprises those devices necessary to implement a wireless system, such as base stations, controllers, resource allocators, interfaces, databases, etc. as generally known in the art. As those having ordinary skill the art will appreciate, the particular elements incorporated into the wireless network 113 is dependent upon the particular type of wireless system 110 used, e.g., a cellular system, a trunked land-mobile system, etc.

A variety of servers 115, 123, 132, 143, 145 maybe provided throughout the system 100 as shown. Each server is capable of communicating with the subscriber units 102-103 via the appropriate infrastructure elements, as known in the art, by executing one or more applications. For example, a given server may implement a publicly-accessible web site application that provides weather-related information. Thus, a given weather report may consist of text and graphics as visual components and speech and tones as audible components. The information sent to a particular subscriber unit can include the weather report as text, icons (such as graphics representative of clouds or sun), and audible components, e.g., spoken weather conditions, background music or tones (such as alerts for severe weather). Servers executing such applications are well-known in the art and need not be described in greater detail herein.

In a preferred embodiment, each of the servers illustrated in FIG. 1 also implements a server portion of a client-server speech recognition and synthesis system, thereby providing speech-based services to users of the subscriber units 102-103. A control entity 116 may also be coupled to the wireless network 113. The control entity 116 can be used to send control signals, responsive to input provided by the speech recognition server 115, to the subscriber units 102-103 to control the subscriber units or devices interconnected to the subscriber units. As shown, the control entity 116, which may comprise any suitably programmed general purpose computer, may be coupled to a server 115 either through the wireless network 113 or directly, as shown by the dashed interconnection.

As noted above, the infrastructure of the present invention can comprise a variety of systems 110, 120, 130, 140 coupled together via a data network 150. A suitable data network 150 may comprise a private data network using known network technologies, a public network such as the Internet, or a combination thereof. The present invention is particularly applicable to variable-delay network technologies, such as packet switched networks. As alternatives, or in addition to, the server 115 within the wireless system 110, remote servers 123, 132, 143, 145 may be connected in various ways to the data network 150 to provide application and/or speech-based services to the subscriber units 102-103. The remote servers, when provided, are similarly capable of communicating with the control entity 116 through the data network 150 and any intervening communication paths.

A computer 122, such as a desktop personal computer or other general-purpose processing device, within a small entity system 120 (such as a small business or home) can be used to implement a server 123. Data to and from the subscriber units 102-103 is routed through the wireless system 110 and the data network 150 to the computer 122. Executing stored software algorithms and processes, the computer 122 provides the functionality of the server 123, which, in the preferred embodiment, includes the server portions of both a speech recognition system and a speech synthesis system as well as applications providing any of a wide variety of services. Where, for example, the computer 122 is a user's personal computer, the speech recognition server software on the computer can be coupled to the user's personal information residing on the computer, such as the user's email, telephone book, calendar, or other information. This configuration would allow the user of a subscriber unit to access personal information on their personal computer utilizing a voice-based interface.

Alternatively, a content or service provider 130, which has information and/or services it would like to make available to users of subscriber units, can connect a server 132 to the data network. The server 132 provides an interface to users of subscriber units desiring access to the content/service provider's information and/or services (not shown).

Another possible location for a server is within an enterprise 140, such as a large corporation or similar entity. The enterprise's internal network 146, such as an Intranet, is connected to the data network 150 via security gateway 142. The security gateway 142 provides, in conjunction with the subscriber units, secure access to the enterprise's internal network 146. As known in the art, the secure access provided in this manner typically relies, in part, upon authentication and encryption technologies. In this manner, secure communications between subscriber units and an internal network 146 via an unsecured data network 150 are provided. Within the enterprise 140, server software implementing a server 145 can be provided on a personal computer 144, such as a given employee's workstation. Similar to the configuration described above for use in small entity systems, the workstation approach allows an employee to access work-related or other information, possibly through a voice-based interface. Also, similar to the content provider 130 model, the enterprise 140 can provide an internally available server 143 to provide access to enterprise databases and/or services.

The infrastructure of the present invention also provides interconnections between the subscriber units 102-103 and normal telephony systems. This is illustrated in FIG. 1 by the coupling of the wireless network 113 to a POTS (plain old telephone system) network 118. As known in the art, the POTS network 118, or similar telephone network, provides communication access to a plurality of calling stations 119, such as landline telephone handsets or other wireless devices. In this manner, a user of a subscriber unit 102-103 can carry on voice communications with another user of a calling station 119.

FIG. 2 illustrates a hardware architecture that may be used to implement a subscriber unit in accordance with the present invention. As shown, two wireless transceivers may be used: a wireless data transceiver 203, and a wireless voice transceiver 204. As known in the art, these transceivers may be combined into a single transceiver that can perform both data and voice functions. The wireless data transceiver 203 and the wireless speech transceiver 204 are both connected to an antenna 205. Alternatively, separate antennas for each transceiver may also be used. The wireless voice transceiver 204 performs all necessary signal processing, protocol termination, modulation/demodulation, etc. to provide wireless voice communication and, in the preferred embodiment, comprises a cellular transceiver. In a similar manner, the wireless data transceiver 203 provides data connectivity with the infrastructure. In a preferred embodiment, the wireless data transceiver 203 supports wireless packet data, such as the General Packet Data Radio Service (GPRS) defined by the European Telecommunications Standards Institute (ETSI).

It is anticipated that the present invention can be applied with particular advantage to in-vehicle systems, as discussed below. When employed in-vehicle, a subscriber unit in accordance with the present invention also includes processing components that would generally be considered part of the vehicle and not part of the subscriber unit. For the purposes of describing the instant invention, it is assumed that such processing components are part of the subscriber unit. It is understood that an actual implementation of a subscriber unit may or may not include such processing components as dictated by design considerations. In a preferred embodiment, the processing components comprise a general-purpose processor (CPU) 201, such as a “POWER PC” by IBM Corp., and a digital signal processor (DSP) 202, such as a DSP56300 series processor by Motorola Inc. The CPU 201 and the DSP 202 are shown in contiguous fashion in FIG. 2 to illustrate that they are coupled together via data and address buses, as well as other control connections, as known in the art. Alternative embodiments could combine the functions for both the CPU 201 and the DSP 202 into a single processor or split them into several processors. Both the CPU 201 and the DSP 202 are coupled to a respective memory 240, 241 that provides program and data storage for its associated processor. Using stored software routines, the CPU 201 and/or the DSP 202 can be programmed to implement at least a portion of the functionality of the present invention. Software functions of the CPU 201 and DSP 202 will be described, at least in part, with regard to FIG. 3 below.

In a preferred embodiment, subscriber units also include a global positioning satellite (GPS) receiver 206 coupled to an antenna 207. The GPS receiver 206 is coupled to the DSP 202 to provide received GPS information. The DSP 202 takes information from GPS receiver 206 and computes location coordinates of the wireless communications device. Alternatively the GPS receiver 206 may provide location information directly to the CPU 201.

Various inputs and outputs of the CPU 201 and DSP 202 are illustrated in FIG. 2. As shown in FIG. 2, the heavy solid lines correspond to voice-related information, and the heavy dashed lines correspond to control/data-related information. Optional elements and signal paths are illustrated using dotted lines. The DSP 202 receives microphone audio 220 from a microphone 270 that provides voice input for both telephone (cellphone) conversations and voice input to both a local speech recognizer and a client-side portion of a client-server speech recognizer, as described in further detail below. The DSP 202 is also coupled to output audio 211 which is directed to at least one speaker 271 that provides voice output for telephone (cellphone) conversations and voice output from both a local speech synthesizer and a client-side portion of a client-server speech synthesizer. Note that the microphone 270 and the speaker 271 may be proximally located together, as in a handheld device, or may be distally located relative to each other, as in an automotive application having a visor-mounted microphone and a dash or door-mounted speaker.

In one embodiment of the present invention, the CPU 201 is coupled through a bi-directional interface 230 to an in-vehicle data bus 208. This data bus 208 allows control and status information to be communicated between various devices 209a-n in the vehicle, such as a cellphone, entertainment system, climate control system, etc. and the CPU 201. It is expected that a suitable data bus 208 will be an ITS Data Bus (IDB) currently in the process of being standardized by the Society of Automotive Engineers. Alternative means of communicating control and status information between various devices may be used such as the short-range, wireless data communication system being defined by the Bluetooth Special Interest Group (SIG). The data bus 208 allows the CPU 201 to control the devices 209 on the vehicle data bus in response to voice commands recognized either by a local speech recognizer or by the client-server speech recognizer.

CPU 201 is coupled to the wireless data transceiver 203 via a receive data connection 231 and a transmit data connection 232. These connections 231-232 allow the CPU 201 to receive control, data and speech-synthesis information sent from the wireless system 110. The speech-synthesis information is received from a server portion of a client-server speech synthesis system via the wireless data channel 105. The CPU 201 decodes the speech-synthesis information that is then delivered to the DSP 202. The DSP 202 then synthesizes the output speech and delivers it to the audio output 211. Any control information received via the receive data connection 231 may be used to control operation of the subscriber unit itself or sent to one or more of the devices in order to control their operation. Additionally, the CPU 201 can send status information, and the output data from the client portion of the client-server speech recognition system, to the wireless system 110. The client portion of the client-server speech recognition system is preferably implemented in software in the DSP 202 and the CPU 201, as described in greater detail below. When supporting speech recognition, the DSP 202 receives speech from the microphone input 220 and processes this audio to provide a parameterized speech signal to the CPU 201. The CPU 201 encodes the parameterized speech signal and sends this information to the wireless data transceiver 203 via the transmit data connection 232 to be sent over the wireless data channel 105 to a speech recognition server in the infrastructure.

The wireless voice transceiver 204 is coupled to the CPU 201 via a bi-directional data bus 233. This data bus allows the CPU 201 to control the operation of the wireless voice transceiver 204 and receive status information from the wireless voice transceiver 204. The wireless voice transceiver 204 is also coupled to the DSP 202 via a transmit audio connection 221 and a receive audio connection 210. When the wireless voice transceiver 204 is being used to facilitate a telephone (cellular) call, audio is received from the microphone input 220 by the DSP 202. The microphone audio is processed (e.g., filtered, compressed, etc.) and provided to the wireless voice transceiver 204 to be transmitted to the cellular infrastructure. Conversely, audio received by wireless voice transceiver 204 is sent via the receive audio connection 210 to the DSP 202 where the audio is processed (e.g., decompressed, filtered, etc.) and provided to the speaker output 211. The processing performed by the DSP 202 will be described in greater detail with regard to FIG. 3.

The subscriber unit illustrated in FIG. 2 may optionally comprise one or more input devices 250 for use in manually providing an input event 251, particularly during a wireless communication. That is, during a wireless communication, a user of the subscriber unit can manually activate any of the input devices to provide an input event, thereby signaling the user's desire to wake up speech recognition functionality. For example, during a wireless communication, which may include voice and/or data communications, the user of the subscriber unit may wish to barge-in in order to provide speech-based commands to an electronic attendant, e.g., to dial up and add a third party to the call. The input device 250 may comprise virtually any type of user-activated input mechanism, particular examples of which include a single or multi-purpose button, a multi-position selector, a menu-driven display with input capabilities, keypads, keyboards, touchpads or touchscreens. Alternatively, the input devices 250 may be connected to the CPU 201 via the bi-directional interface 230 and the in-vehicle data bus 208. Regardless, when such input devices 250 are provided, the CPU 201 acts as a detector to identify the occurrence of an input event, for example by polling the input devices 250 or through the use of a dedicated interrupt request line, as known in the art. When the CPU 201 acts as a detector for the input devices 250, the CPU 201 indicates the presence of the interrupt indicator to the DSP 202, as illustrated by the signal path identified by the reference numeral 260. Conversely, another implementation uses a local speech recognizer (preferably implemented within the DSP 202 and/or CPU 201) coupled to a detector application to provide the input event. In that case, either the CPU 201 or the DSP 202 would signal the presence of the input event, as represented by the signal path identified by the reference numeral 260a. In a preferred embodiment, such a message indicating that the input event constitutes a barge-in request is conveyed via the transmit data connection 232 to the wireless data transceiver 203 for transmission to a server communicating with the subscriber unit.

Finally, the subscriber unit is preferably equipped with an annunciator 255 for providing an indication to a user of the subscriber unit in response to annunciator control 256 that the speech recognition functionality has been activated in response to the input event. The annunciator 255 is activated in response to the detection of the input event, and may comprise a speaker used to provide an audible indication, such as a limited-duration tone or beep. (Again, the presence of the input event can be signaled using either the input device-based signal 260 or the speech-based signal 260a.) In another implementation, the functionality of the annunciator is provided via a software program executed by the DSP 202 that directs audio to the speaker output 211. The speaker may be separate from or the same as the speaker 271 used to render the audio output 211 audible. Alternatively, the annunciator 255 may comprise a display device, such as an LED or LCD display, that provides a visual indicator or that functions as a graphic display device. The particular form of the annunciator 255 is a matter of design choice, and the present invention need not be limited in this regard. Further still, the annunciator 255 may be connected to the CPU 201 via the bi-directional interface 230 and the in-vehicle data bus 208.

FIG. 3 illustrates functionality of a subscriber unit in accordance with the present invention. Preferably, the processing illustrated in FIG. 3 is implemented using machine-readable instructions executed by the CPU 201 and/or the DSP 202, and stored in the corresponding memories 240, 241.

A plurality of input devices is provided, including atouchpad 360, button/keypad 362 and a microphone 371. It is understood that the input devices illustrated in FIG. 3 are exemplary only, other such devices could be provided instead of or in addition to the input devices illustrated, and the present invention is not limited in this regard. Regardless of the types of input devices used, each such input device is coupled to a corresponding activity or event detector. In the example of FIG. 3, the touchpad 360 is coupled to a touchpad activity detector 352; the button/keypad 362 is coupled to a button/keypad activity detector 354; and the microphone is coupled to a voice/tone activity detector 356. Note that an optional dotted line connection is also illustrated between the button/keypad 362 and the voice/tone activity detector 356; this exemplifies the scenario in which a DTMF keypad is used to generate tones. In each case, operation of the respective activity detector is dependent upon the type of input device to which the activity detector is coupled. Thus, the touchpad activity detector 352 comprises a well-known mechanism for sensing the occurrence of a user touching the touchpad. The button/keypad activity detector 354 uses conventional button/keypad polling or interrupt detection techniques to determine the occurrence of a button/key press by a user. Likewise, the voice/tone activity detector 356 uses well-known speech detection and tone detection techniques. Note that any adequate representations of a speech or audio (e.g., tone) signal may be used by the voice/tone activity detector 356. That is, the speech or audio information provided to the activity detector 356 may comprise any of a variety of parameterized or unparameterized representations, including raw digitized audio, audio that has been processed by a cellular speech coder, audio data suitable for transmission according to a specific protocol such as IP (Internet Protocol), etc. Furthermore, the voice/tone activity detection can be done based on either energy detection or actual interpretation of the input or as an output of the encoding algorithm. In the case of energy detection, any change from silence to a higher energy level because of a tone or speech is recognized and results in a detection indication. In the case of actual interpretation, the input is analyzed and determined to be legitimate (e.g., a recognized utterance or tone) before a detection indication is provided. This technique is meant to mitigate the effects of extraneous inputs due to background noise.

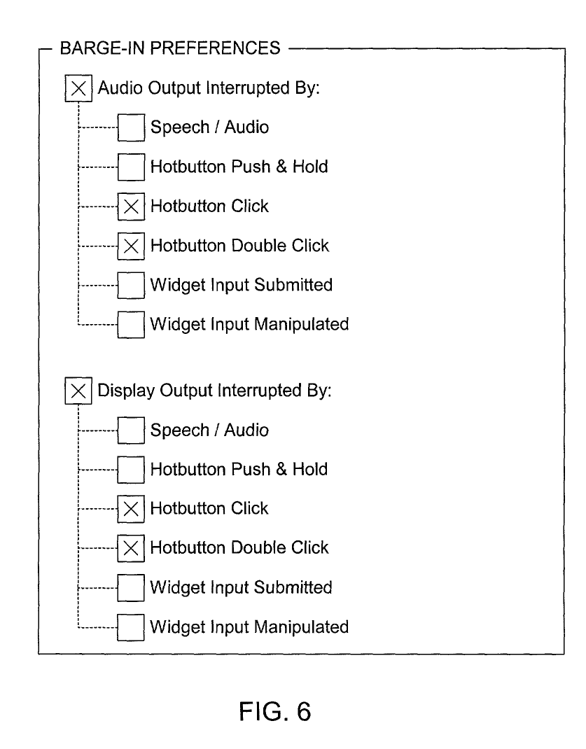

In accordance with one embodiment of the present invention, each of the activity detectors 352-356 is provided at least a portion of input event prioritization data (received from a source external to the subscriber unit, such as a server) that is used to determine whether a detected input event is actually a valid barge-in request. In essence, the input event prioritization data can be thought of as a filter that establishes the conditions in which a detected input event will be flagged to the subscriber unit (and infrastructure) as a valid barge-in event. Additional description of the input event prioritization data is provided below with reference to FIG. 6. In the embodiment illustrated in FIG. 3, the input event prioritization data is provided to the barge-in detector 340 that, in turn, uses the input event prioritization data to determine when a detected input event meets the criteria for a valid barge-in request.

A playback unit 350 is provided for converting subscriber-targeted information (the information output messages) to an output suitable for presentation via an output device 369, 370. In particular, audio data (including, for example, received speech, synthesized speech, tones, etc.), is rendered audible by the playback unit 350 and provided to a speaker 370. Techniques for rendering various types of audio data are well-known in the art and need not be described in detail here. Likewise, display or graphic data is rendered viewable by the playback unit 350 and provided to a display 369, if available. Once again, techniques for rendering various types of display data visible on a display are well-known in the art and are not described in detail here. Although not shown in FIG. 3, the subscriber-targeted information, as it is received, can be buffered prior to conversion by the playback unit 350.

One aspect of the present invention is that the validity of barge-in events is preferably dependent upon the type of output data (as determined by the type of subscriber-targeted information currently being converted by the playback unit) being provided by the playback unit 350 at the time an input event is detected, as well as the type of input event detected. Thus, the subscriber-targeted information preferably includes an indication of the type of data that it represents. For example, the messages conveying the subscriber-targeted information preferably indicate, at a minimum, whether the data contained therein comprises audio data or display data. This aspect of the present invention is more fully described with reference to FIG. 6 below.

A barge-in detector 340 is coupled to the each of the activity detectors 352-356 and the playback unit 350. The barge-in detector 340 takes in indications of input events from each of the activity detectors 352-356 as well as an indication from the playback unit 350 that playback is currently operational. A barge-in enable signal from a source external to the subscriber unit (e.g., a server) needs to be asserted before the barge-in detector will be allowed to detect barge-ins. In this manner, for example, an application executed by a server can control the ability for barge-in to occur while the server-based application is providing subscriber-targeted information to the subscriber unit. Also, as illustrated by the dotted line, the barge-in detector 340 ascertains at any given moment what type of output is being provided by the playback unit 350, e.g., audio data or display data. Based on these inputs, the barge-in detector 340 determines whether a given input event is a valid barge-in occurrence based on the input event prioritization data. While the input event prioritization data may be used in a centralized manner by the barge-in detector 340, it is understood that the input event prioritization data could also be used in a distributed manner. For example, the detectors 352-356 could communicate directly with the playback unit 350. The input event prioritization data could be distributed across the detectors 352-356 and the playback unit 350 could provide each of the detectors 352-356 with the indication that playback is currently operational (the “PLAYBACK ON” signal). The decision making performed by the barge-in detector 340 is effectively split up among the different detectors in this scenario, thereby eliminating the need for the barge-in detector 340. Regardless of whether it is used in a centralized or distributed manner, the input event prioritization data is further described with reference to FIG. 6, which illustrates a presently preferred technique for establishing conditions for valid barge-in requests.

As shown in FIG. 6, a plurality of preferred types of subscriber-targeted information (Audio Output, Display Output) are listed with corresponding sets of input events (Speech/Audio, Hotbutton Push & Hold, Hotbutton Click, Hotbutton Double Click, Widget Input Submitted, Widget Input Manipulated) that may serve to establish a barge-in request. A Speech/Audio input event corresponds to activity detection by a voice/tone activity detector. A Hotbutton Push & Hold input event corresponds to the detection of the activation of a predetermined button or key (i.e., the “Hotbutton”) and holding of that button or key in the activated position (e.g., closed for a normally open button or key). A Hotbutton Click or Hotbutton Double Click input event corresponds to single press and release or double press and release, respectively, within a predetermined period of time. A technique for implementing the “Hotbutton” input events described herein is disclosed in co-pending U.S. patent application Ser. No. XX/XXX,XXX by Buchholz et al., entitled MULTI-FUNCTION, MULTI-STATE INPUT CONTROL DEVICE, filed on even date herewith and having attorney docket number 33686.00.0012, the teachings of which application are hereby incorporated by reference verbatim, with the same effect as though the prior application was fully and completely set forth herein. The Widget Input Manipulated input event corresponds to a simple manipulation of a graphical user interface (GUI) element, such as entering text in a text box or selecting and filling a data field using a pull-down menu without actually sending the data entered by virtue of the manipulation of the element. The Widget Input Submitted input event, in contrast, corresponds to activation of GUI elements that cause data to be submitted, as opposed to merely entered, e.g., a soft button or icon activation or a hyperlink click. Those having ordinary skill in the art will appreciate that other type of input events, which events may be more specifically or broadly defined, are possible.

Based on which options are selected, various input events may be recognized as valid barge-in events. In essence, the input event prioritization data illustrated in FIG. 6 allows various input events to be conditioned or filtered by a subscriber unit before they will be recognized as barge-in attempts. In the example illustrated, valid barge-in attempts are recognized during the playback of audio or display data only when input events falling within the categories of “Hotbutton Click” or “Hotbutton Double Click” are detected. In a preferred embodiment, these input events are set as the default input events capable of giving rise to a barge-in request. In one aspect of the present invention, these default designations may be modified by input event prioritization data provided by a source external to the subscriber unit, e.g., a server that the subscriber unit is currently communicating with. Note also that, although the illustration in FIG. 6 is akin to a user-modifiable input screen, in practice, the designation of valid barge-in events is not modifiable by subscriber unit users, but rather is set to a default configuration when the software is installed and is further controlled by applications operating on servers that communicate with the subscriber units.

Referring again to FIG. 3, the barge-in detector 340 provides a barge-in detected signal when a suitable input event is detected. The barge-in detected signal is provided to the playback unit 350 such that the playback unit, upon receiving the barge-in detected signal, can immediately halt further presentation of output data based on any stored or subsequently-received subscriber-targeted information. That is, further conversion of any stored subscriber-targeted information is ceased, and any subsequently-received subscriber-targeted information is ignored. The barge-in detection signal also preferably indicates to the playback unit 350 which type of output to halt, e.g., audio, display or both. In this manner, the subscriber unit is perceived as being highly responsive to the barge-in request, regardless of the variable delays in the network used to convey information to and from the subscriber unit. Upon resuming the output of information to the subscriber device, the server indicates that the information messages being sent are to be presented to the user and are different from the messages sent previously and impacted by the barge-in event.

Finally, a reliable transfer unit (RTU) 330 is coupled to the playback unit 350 and barge-in detector 340. The RTU 330 comprises all interface circuitry and functionality needed for the subscriber unit to communicate with the source of the subscriber-targeted information, i.e., a server. For example, with reference to FIG. 2, the RTU 330 would comprise the wireless data and voice transceivers 203, 204 and related functionality implemented by the CP 201 and DSP 202 used to support the transceivers. As shown in FIG. 3, the RTU manages the reception of the information output messages (the subscriber-targeted information), the barge-in enable signal and the input event prioritization data. Additionally, the RTU provides the barge-in detected signal to the source of the subscriber-targeted information. In this manner, the occurrence of a barge-in can be communicated to the source of the subscriber-targeted information at substantially the same time the playback unit 350 halts further playback. In a preferred embodiment, the barge-in detected signal sent by the RTU to the source of the subscriber-targeted information comprises an indication of a valid barge-in and information regarding the input event. The indication of a valid barge-in is preferably conveyed using a selectable field within a standard message; when a valid barge-in event has occurred, the field is set or asserted. The information regarding the input event preferably comprises a type of the input event that gave rise to the valid barge-in, e.g., a Hotbutton Press & Hold.

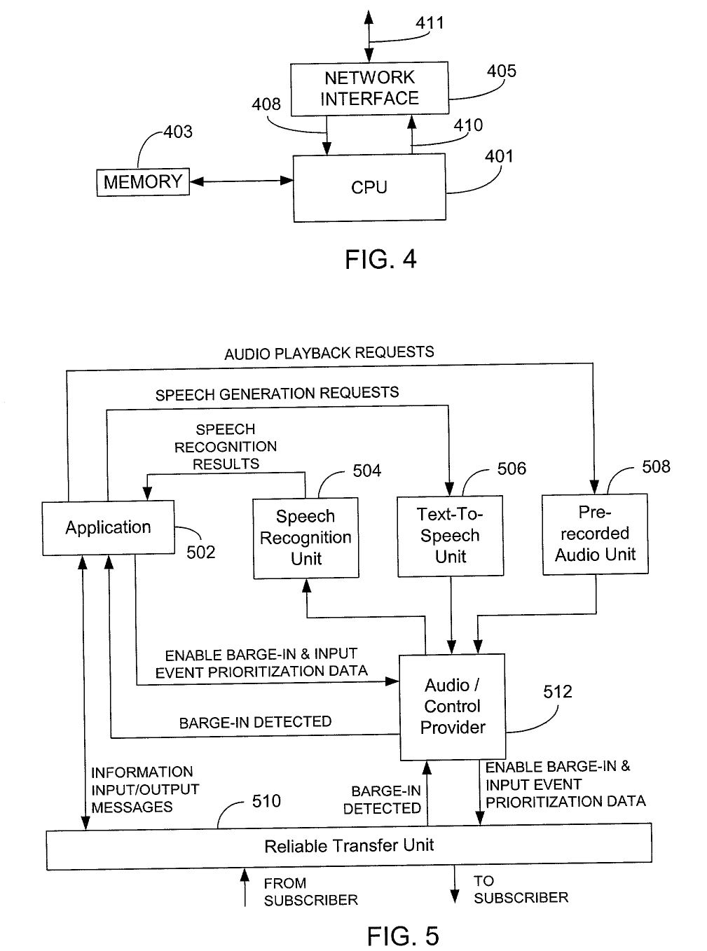

Referring now to FIG. 4, there is illustrated a hardware embodiment of a server in accordance with the present invention. This server can reside in several environments as described above with regard to FIG. 1. Data communication with subscriber units or a control entity is enabled through an infrastructure or network connection 411. This connection 411 may be local to, for example, a wireless system and connected directly to a wireless network, as shown in FIG. 1. Alternatively, the connection 411 may be to a public or private data network, or some other data communications link; the present invention is not limited in this regard.

A network interface 405 provides connectivity between a CPU 401 and the network connection 411. The network interface 405 routes data from the network 411 (e.g., barge-in detected signals from subscriber unit) to CPU 401 via a receive path 408, and from the CPU 401 to the network connection 411 (e.g., subscriber-targeted information, barge-in enable signals and input event prioritization data) via a transmit path 410. As part of a client-server arrangement, the CPU 401 communicates with one or more clients (preferably implemented in subscriber units) via the network interface 405 and the network connection 411. In a preferred embodiment, the CPU 401 implements the server portion of the client-server speech recognition and synthesis system. Although not shown, the server illustrated in FIG. 4 may also comprise a local interface allowing local access to the server thereby facilitating, for example, server maintenance, status checking and other similar functions.

A memory 403 stores machine-readable instructions (software) and program data for execution and use by the CPU 401 in implementing the server portion of the client-server arrangement. The operation and structure of this software is further described with reference to FIG. 5.

FIG. 5 illustrates functionality of a server in accordance with the present invention. Preferably, the processing illustrated in FIG. 5 is implemented using machine-readable instructions executed by the CPU 401 and stored in the corresponding memory 403. In particular, at least one application 502, as described above, is implemented by the server. The application 502 communicates with a subscriber unit via an RTU 510, wherein the RTU embodies the network interface 405 and supporting functionality implemented by the CPU 401. In particular, the application provides subscriber-targeted information to the subscriber unit. The application also receives speech recognition results from a speech recognition unit 504, and provides speech generation requests and audio playback requests to a text-to-speech unit 506 and pre-recorded audio unit 508, respectively.

Audio data (not shown) is routed by the audio/control provider 512 from the RTU (subscriber unit) to the speech recognition unit 504, and from the text-to-speech unit 506 and/or pre-recorded audio unit 508 to the RTU. Implementations of the speech recognition unit 504, the text-to-speech unit 506 and the pre-recorded audio unit 508 are well-known to those having ordinary skill in the art. The audio/control provider 512 also routes control-related information to and from the application 502. In particular, a barge-in enable signal, when asserted by the application, as well as input event prioritization data provided by the application are sent to the RTU, whereas barge-in detected signals received by the RTU are routed to the application. When the application receives a barge-in detected signal from subscriber unit via the RTU 510, it knows to cease further transmission of subscriber-targeted information to that subscriber unit. Thereafter, the application processes subsequently received information regarding additional input events (received at the subscriber unit after the occurrence of the barge-in) that may be provided to the application via information input messages from the subscriber unit, or as speech recognition results from the speech recognition unit 504. In response to the information regarding the additional input events, the application may cause additional or different input event prioritization data to be sent to the subscriber unit, for example, in the case where the information regarding the additional input events indicates that the user is switching modes of operation of the service provided by the application.

The present invention as described above provides a technique for processing input events indicative of a barge-in request in a timely and responsive manner. To this end, a subscriber unit locally detects input events and determines whether the input events constitute of valid barge-in request based on externally-provided input event prioritization data. When the subscriber unit detects a valid barge-in, playback of any subscriber-targeted information is immediately halted, thereby presenting rapid responsiveness to the barge-in, regardless of any network variability. What has been described above is merely illustrative of the application of the principles of the present invention. Other arrangements and methods can be implemented by those skilled in the art without departing from the spirit and scope of the present invention.

What is claimed is:

1. In a subscriber unit capable of wireless communication with an infrastructure, the infrastructure comprising a server, a method comprising:
engaging in a wireless communication between the subscriber unit and the server via the infrastructure, wherein subscriber-targeted information provided by the server is provided as output at the subscriber unit during the wireless communication;
locally detecting, during the wireless communication, an input event; and
discontinuing presentation of the subscriber-targeted information as the output at the subscriber unit in response to detection of the input event.

2. The method of claim 1, wherein the step of locally detecting further comprises:
determining whether the input event constitutes a valid barge-in event based on a type of the subscriber-targeted information that is being provided as the output when the input event is detected.

3. The method of claim 1, wherein the step of locally detecting further comprises:
determining whether the input event constitutes a valid barge-in event based on a type of the input event.

4. The method of claim 1, wherein the local detection further comprises detecting activation of an input device operatively coupled to the subscriber unit.

5. The method of claim 1, wherein the step of discontinuing further comprises ignoring the subscriber-targeted information that is received after the input event has been detected.

6. The method of claim 1, wherein the step of discontinuing further comprises ceasing presentation of any of the subscriber-targeted data that has been stored prior to the detection of the input event.

7. The method of claim 1, further comprising:
detecting additional input events subsequent to the input event; and
sending at least information regarding the additional input events to the server.

8. In a subscriber unit capable of wireless communication with an infrastructure, the infrastructure comprising a server, a method comprising steps of:
engaging in a wireless communication between the subscriber unit and the server via the infrastructure, wherein subscriber-targeted information provided by the server is provided as output at the subscriber unit during the wireless communication;
locally detecting, during the wireless communication, an input event; and
transmitting, to the server and in response to the input event, a message that causes the server to discontinue presentation of the subscriber-targeted information to the subscriber unit.

9. The method of claim 8, wherein the step of locally detecting further comprises:
determining whether the input event constitutes a valid barge-in event based on a type of the subscriber-targeted information that is being provided as the output when the input event is detected.

10. The method of claim 8, wherein the step of locally detecting further comprises:
determining whether the input event constitutes a valid barge-in event based on a type of the input event.

11. The method of claim 8, wherein the local detection further comprises detecting activation of an input device operatively coupled to the subscriber unit.

12. The method of claim 8, wherein the message comprises an indication of a valid barge-in and information regarding the input event.

13. The method of claim 8, further comprising:
detecting additional input events subsequent to the input event; and
sending at least information regarding the additional input events to the server.

14. In a subscriber unit capable of wireless communication with an infrastructure, the infrastructure comprising a server, a method comprising steps of:
receiving, from the server, input event prioritization data;
engaging in a wireless communication between the subscriber unit and the server via the infrastructure, wherein subscriber-targeted information provided by the server is provided as output at the subscriber unit during the wireless communication;
locally detecting, during the wireless communication, an input event; and
determining whether the input event constitutes a barge-in request relative to the wireless communication based at least in part upon the input event prioritization data.

15. The method of claim 14, wherein the input event prioritization data comprises information regarding at least one type of the subscriber-targeted information.

16. The method of claim 15, wherein the information regarding the at least one type of the subscriber-targeted information comprises either of an audio data type and a display data type.

17. The method of claim 14, wherein the input event prioritization data comprises information regarding at least one type of the input event.

18. The method of claim 14, further comprising:
discontinuing presentation of the subscriber-targeted information as the output at the subscriber unit in response to determination that the input event constitutes a barge-in request.

19. The method of claim 14, further comprising:
transmitting, to the server and in response to the input event, a message that causes the server to discontinue presentation of the subscriber-targeted information to the subscriber unit.

20. In a server forming a part of an infrastructure, the infrastructure in wireless communication with at least one subscriber unit, a method comprising:
engaging in a wireless communication between the server via the infrastructure and the subscriber unit, wherein subscriber-targeted information provided by the server is provided as output at the subscriber unit during the wireless communication;
enabling barge-in by the subscriber unit during the wireless communication;
receiving, from the subscriber unit, a message that indicates the detection, at the subscriber unit, of a barge-in request; and
discontinuing presentation of the subscriber-targeted information to the subscriber unit in response to the message.

21. The method of claim 20, further comprising:
receiving, from the subscriber unit, at least information regarding additional input events, wherein the additional input events are detected at the subscriber unit after detection of the barge-in request; and
processing the at least information regarding additional input events as input data to an application executed by the server.

22. The method of claim 20, further comprising:
providing, to the subscriber unit, input event prioritization data,
wherein the input event prioritization data is used by the subscriber unit to determine whether an input event detected at the subscriber unit is a valid barge-in request.

23. In a server forming a part of an infrastructure, the infrastructure in wireless communication with at least one subscriber unit, a method comprising:
providing, to the subscriber unit, input event prioritization data;
engaging in a wireless communication between the server via the infrastructure and the subscriber unit, wherein subscriber-targeted information provided by the server is provided as output at the subscriber unit during the wireless communication; and
receiving, from the subscriber unit, a message that indicates the detection, at the subscriber unit, of a barge-in request,
wherein the message is sent by the subscriber unit in response to detection, at the subscriber unit of an input event that constitutes a valid barge-in request based on the input event prioritization data.

24. The method of claim 23, further comprising:
discontinuing presentation of the subscriber-targeted information to the subscriber unit in response to the message.

25. The method of claim 23, further comprising:
receiving, from the subscriber unit, at least information regarding additional input events, wherein the additional input events are detected at the subscriber unit after detection of the barge-in request; and
processing the at least information regarding additional input events as input data to an application executed by the server.

26. A subscriber unit capable of wireless communication with an infrastructure comprising a server, the subscriber unit comprising:
means for engaging in a wireless communication between the subscriber unit and the server via the infrastructure, wherein subscriber-targeted information provided by the server is provided as output at the subscriber unit during the wireless communication;
means for locally detecting, during the wireless communication, an input event; and
means for discontinuing presentation of the subscriber-targeted information as the output at the subscriber unit in response to detection of the input event.

27. The subscriber unit of claim 26, wherein the means for locally detecting further function to determine whether the input event constitutes a valid barge-in event based on a type of the subscriber-targeted information that is being provided as the output when the input event is detected.

28. The subscriber unit of claim 26, wherein the step of locally detecting further comprises:
determining whether the input event constitutes a valid barge-in event based on a type of the input event.

29. The subscriber unit of claim 26, wherein the means for locally detecting further comprise an input device.

30. The subscriber unit of claim 26, wherein the means for discontinuing further functions to ignore the subscriber-targeted information that is received after the input event has been detected.

31. The subscriber unit of claim 26, wherein the means for discontinuing further functions to cease reproduction of any of the subscriber-targeted data that has been stored prior to the detection of the input event.

32. The subscriber unit of claim 26, wherein the means for locally detecting further function to detect additional input events subsequent to the input event, and wherein the subscriber unit further comprises:
means for sending at least information regarding the additional input events to the server.

33. A subscriber unit capable of wireless communication with an infrastructure comprising a server, the subscriber unit comprising:
means for engaging in a wireless communication between the subscriber unit and the server via the infrastructure, wherein subscriber-targeted information provided by the server is provided as output at the subscriber unit during the wireless communication;
means for locally detecting, during the wireless communication, an input event; and
means for transmitting, to the server and in response to the input event, a message that causes the server to discontinue presentation of the subscriber-targeted information to the subscriber unit.

34. The subscriber unit of claim 33, wherein the means for locally detecting further functions to determine whether the input event constitutes a valid barge-in event based on a type of the subscriber-targeted information that is being provided as the output when the input event is detected.

35. The subscriber unit of claim 33, wherein the means for locally detecting further functions to determine whether the input event constitutes a valid barge-in event based on a type of the input event.

36. The subscriber unit of claim 33, wherein the means for locally detecting further comprises an input device.

37. The subscriber unit of claim 33, wherein the message comprises an indication of a valid barge-in and information regarding the input event.

38. The subscriber unit of claim 33, wherein the means for locally detecting further function to detect additional input events subsequent to the input event, the subscriber unit further comprising:
means for sending at least information regarding the additional input events to the server.

39. A subscriber unit capable of wireless communication with an infrastructure comprising a server, the subscriber unit comprising:
means for receiving, from the server, input event prioritization data;
means for engaging in a wireless communication between the subscriber unit and the server via the infrastructure, wherein subscriber-targeted information provided by the server is provided as output at the subscriber unit during the wireless communication;
means for locally detecting, during the wireless communication, an input event; and
means for determining whether the input event constitutes a barge-in request relative to the wireless communication based at least in part upon the input event prioritization data.

40. The subscriber unit of claim 39, wherein the input event prioritization data comprises information regarding at least one type of the subscriber-targeted information.

41. The subscriber unit of claim 40, wherein the information regarding the at least one type of the subscriber-targeted information comprises either of an audio data type and a display data type.

42. The subscriber unit of claim 39, wherein the input event prioritization data comprises information regarding at least one type of the input event.

43. The subscriber unit of claim 39, further comprising:
means for discontinuing presentation of the subscriber-targeted information as the output at the subscriber unit in response to determination that the input event constitutes a barge-in request.

44. The subscriber unit of claim 39, further comprising:
means for transmitting, to the server and in response to the input event, a message that causes the server to discontinue presentation of the subscriber-targeted information to the subscriber unit.

45. A server forming a part of an infrastructure in wireless communication with at least one subscriber unit, the server comprising:
means for engaging in a wireless communication between the server via the infrastructure and the subscriber unit, wherein subscriber-targeted information provided by the server is provided as output at the subscriber unit during the wireless communication;
means for enabling barge-in by the subscriber unit during the wireless communication;
means for receiving, from the subscriber unit, a message that indicates the detection, at the subscriber unit, of a barge-in request; and
means for discontinuing presentation of the subscriber-targeted information to the subscriber unit in response to the message.

46. The method of claim 45, further comprising:
means for receiving, from the subscriber unit, at least information regarding additional input events, wherein the additional input events are detected at the subscriber unit after detection of the barge-in request; and
means for processing the at least information regarding additional input events as input data to an application executed by the server.

47. The method of claim 45, further comprising:
means for providing, to the subscriber unit, input event prioritization data,
wherein the input event prioritization data is used by the subscriber unit to determine whether an input event detected at the subscriber unit is a valid barge-in request.

48. A server forming a part of an infrastructure in wireless communication with at least one subscriber unit, a method comprising:
means for providing, to the subscriber unit, input event prioritization data;
means for engaging in a wireless communication between the server via the infrastructure and the subscriber unit, wherein subscriber-targeted information provided by the server is provided as output at the subscriber unit during the wireless communication; and
means for receiving, from the subscriber unit, a message that indicates the detection, at the subscriber unit, of a barge-in request,
wherein the message is sent by the subscriber unit in response to detection, at the subscriber unit of an input event that constitutes a valid barge-in request based on the input event prioritization data.

49. The server of claim 48, further comprising:
means for discontinuing presentation of the subscriber-targeted information to the subscriber unit in response to the message.

50. The server of claim 48, further comprising:
means for receiving, from the subscriber unit, at least information regarding additional input events, wherein the additional input events are detected at the subscriber unit after detection of the barge-in request; and
means for processing the at least information regarding additional input events as input data to an application executed by the server.
